(19) United States
(12) Patent Application Publication
(10) Pub. No.: US 2024/0236566 A1
(43) Pub. Date: Jul. 11, 2024

(54) CONTROL METHOD AND DEVICE THEREOF

(71) Applicant: Lenovo (Beijing) Limited, Beijing (CN)

(72) Inventors: Liping WANG, Beijing (CN); Fuxing MA, Beijing (CN)

(21) Appl. No.: 18/408,913

(22) Filed: Jan. 10, 2024

(30) Foreign Application Priority Data
Jan. 11, 2023 (CN) 202310041792.6

(51) Int. Cl. H04R 3/12; H04R 1/40; H04R 29/00

(52) U.S. Cl. CPC H04R 3/12; H04R 1/403; H04R 29/002; H04R 2430/01

(57) ABSTRACT

A control method includes: determining whether first parameters reported by a plurality of speakers satisfy a target condition, the plurality of speakers being disposed at different positions in an electronic device, and each first parameter describing a power supply signal of each speaker; and controlling the plurality of speakers to change their first gain to a same second gain.

### CROSS-REFERENCE TO RELATED APPLICATION

This application claims priority to Chinese Patent Application No. 202310041792.6, filed on Jan. 11, 2023, and the entire content of which is incorporated herein by reference.

### TECHNICAL FIELD

The present disclosure relates to the technical field of electronic control technology, and more particularly, to a control method and a control device.

### BACKGROUND

In a speaker array of an electronic device, due to placement variations of speakers on the motherboard, a link impedance from the battery voltage to each speaker end is different, resulting in a different voltage value detected by each speaker. As such, when a user plays audio and video signals, sound signals output by different speakers fluctuate, thereby degrading user experience.

### SUMMARY

One aspect of the present disclosure provides a control method. The control method includes: determining whether first parameters reported by a plurality of speakers satisfy a target condition, the plurality of speakers being disposed at different positions in an electronic device, and each first parameter describing a power supply signal of each speaker; and controlling the plurality of speakers to change their first gain to a same second gain.

Another aspect of the present disclosure provides a control method being applied to a speaker of an electronic device. The control method includes: in response to determining that a first parameter is smaller than a first threshold, sending the first parameter to a control unit of the electronic device, the first parameter describing a power supply signal of the speaker; receiving a first instruction sent from the control unit under the circumstance that the first parameter satisfies a target condition; and based on the first instruction, adjusting a current first gain to a second gain that is same as a target speaker.

Another aspect of the present disclosure provides an electronic device. The electronic device includes: a power supply circuit configured to at least supply power to a plurality of speakers; the plurality of speakers disposed at different positions of the power supply circuit for outputting audio signals; and a controller connected to the plurality of speakers and configured to receive first parameters sent by at least one speaker through a first interface, and to control the plurality of speakers to change their first gain to a same second gain under the circumstance that the first parameters reported by the plurality of speakers satisfy a target condition.

### BRIEF DESCRIPTION OF THE DRAWINGS

FIG. 1 is a flowchart of an exemplary control method according to some embodiments of the present disclosure;

FIG. 2 is a flowchart of another exemplary control method according to some embodiments of the present disclosure;

FIG. 3 is an exemplary power supply signal threshold table according to some embodiments of the present disclosure;

FIG. 4 is a flowchart of another exemplary control method according to some embodiments of the present disclosure;

FIG. 5 is a schematic structural diagram of an exemplary electronic device according to some embodiments of the present disclosure;

FIG. 6 is a schematic structural diagram of another exemplary electronic device according to some embodiments of the present disclosure; and

FIG. 7 is a schematic structural diagram of another exemplary electronic device according to some embodiments of the present disclosure.

### DETAILED DESCRIPTION OF THE EMBODIMENTS

To make the purpose, technical solutions, and advantages of the present disclosure clearer, the technical solutions in the embodiments of the present disclosure will be clearly and entirely described below in conjunction with the accompanying drawings in the embodiments of the present disclosure. Obviously, the described embodiments are merely part of the embodiments of the present disclosure, but not all of them. Based on the embodiments in the present disclosure, all other embodiments obtained by those of ordinary skill in the art without creative efforts fall within the scope of the present disclosure. Under the circumstances of no conflict, the embodiments and features in the embodiments in the present disclosure can be combined with each other arbitrarily. The steps illustrated in the flowcharts in the drawings may be performed in a computer system in the form of computer-executable instructions. Although a logical order may be shown in the flowchart diagrams, under certain circumstances, the steps shown or described may be performed in a different order than herein.

The technical solutions of the present disclosure will be further described in detail below with reference to the accompanying drawings and various embodiments of the description.

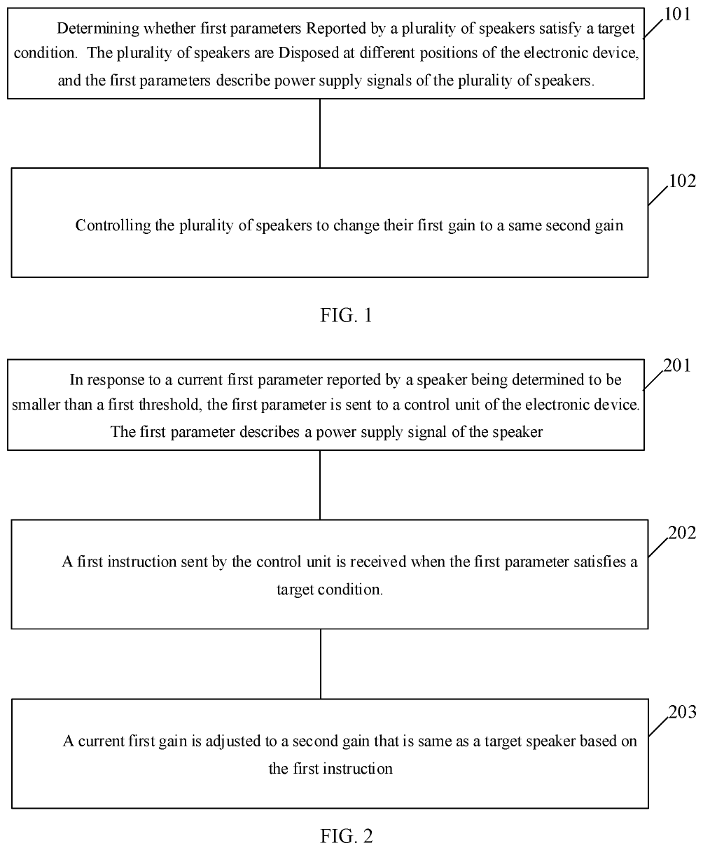

FIG. 1 is a flowchart of an exemplary control method according to some embodiments of the present disclosure. The control method may be applied to an electronic device. For example, the electronic device may be a computer, a server, a mobile phone, a TV set, and other devices with an audio output function. Specifically, the control method can be applied to the controller of the electronic device. As shown in FIG. 1, the control method includes the following processes.

At 101, whether first parameters reported by a plurality of speakers satisfy a target condition is determined. The plurality of speakers are disposed at different positions of the electronic device, and the first parameters describe power supply signals of the plurality of speakers.

In some embodiments, the plurality of speakers are disposed at different positions in the electronic device. In other words, each of the plurality of speakers is disposed at a different position on a motherboard of the electronic device, and has a different distance away from a battery (i.e., a power source) on the motherboard. When the electronic device supplies power to each of the plurality of speakers through the battery on the motherboard, different power supply signals may be detected by the plurality of speakers respectively due to the different distances between each of the plurality of speakers and a power supply voltage of the battery.

For example, each of the plurality of speakers detects different voltage values and different current values.

In the present disclosure, during a startup process of the electronic device, the speaker firmware may send a power supply signal threshold table to the plurality of speakers in the electronic device, respectively. The power supply signal threshold table stores relationships between power supply signal thresholds and signal gains. When a speaker in the electronic device detects a power supply signal from the battery, the power supply signal is compared with a first threshold in the power supply signal threshold table. According to the comparison result, the speaker having a current power supply signal smaller than the first threshold sends the power supply signal detected by itself as a first parameter to the controller of the electronic device, such as a central processing unit (CPU).

The electronic device may receive the first parameter sent by at least one of the plurality of speakers when the first parameter is smaller than the first threshold through the CPU. The electronic device may count the number of speakers reporting their first parameter through the CPU, and control the plurality of speakers to adjust their gains based on the counted number of speakers.

In some embodiments, the electronic device obtains the power supply signal threshold table stored in the speaker firmware through the CPU. Based on the power supply signal threshold table, all received first parameters are respectively compared with the first threshold in the power supply signal threshold table. When it is determined according to the comparison result that all the first parameters are smaller than the first threshold, it is determined that the first parameters satisfy the target condition.

In some other embodiments, when the electronic device determines that all received first parameters are smaller than the first threshold based on the comparison result, the electronic device may also determine the number of speakers whose first parameters are smaller than the first threshold. The obtained number of speakers is compared with a second threshold (here refers to a threshold for the number of speakers) to obtain another comparison result. If the comparison result indicates that the number of speakers is greater than or equal to the second threshold, it is determined that the first parameters reported by the speakers satisfy the target condition.

In this case, the first parameters reported by the speakers satisfying the target condition may specifically refer to that the plurality of speakers reporting the first parameters satisfy a gain adjustment condition.

For example, the electronic device has a total of 10 speakers, among which the number of speakers reporting the first parameters to the CPU is 7, and 7 is greater than the second threshold 6. Then, it is determined that the first parameters reported by the speakers satisfy the gain adjustment condition.

On the contrary, if the comparison result indicates that the number of speakers is smaller than the second threshold, it is determined that the first parameters reported by the speakers do not satisfy the target condition.

For example, the electronic device has a total of 10 speakers, and the number of speakers reporting the first parameter to the CPU is 3. If 3 is smaller than the second threshold 6, it is determined that the first parameters reported by the speakers do not satisfy the gain adjustment condition.

In some embodiments, when the electronic device determines that all received first parameters are smaller than the first threshold based on the comparison results, the electronic device may also obtain speaker position information for the speakers whose first parameter is smaller than the first threshold. Whether the first parameters reported by the speakers meet the target condition may be determined based on the speaker position information.

Further, when the electronic device determines that the first parameters reported by the speakers satisfy the target condition based on the speaker position information, the electronic device may also determine the number of speakers disposed at a same position based on the speaker position information, and may compare the number of speakers disposed at the same position with the second threshold (here refers to a threshold for the number of speakers) to obtain a comparison result. If the comparison result indicates that the number of speakers is greater than or equal to the second threshold, it is determined that the first parameters reported by the speakers satisfy the target condition.

For example, the electronic device has a total of 10 speakers. Speakers 1-5 are disposed in a first position area, and speakers 6-10 are disposed in a second position area. Speakers 2 and 3 disposed in the first position area report their detected first parameters to the CPU. Speakers 6 to 10 disposed in the second position area all report their detected first parameters to the CPU. By obtaining the number of speakers and the speaker position information for the speakers that report their first parameters, it is determined that the number of speakers disposed in the first position area is 2, and the number of speakers disposed in the second position area is 5. The number of speakers 2 and the number of speakers 5 are respectively compared with the second threshold 5. According to the comparison results, it is determined that the number of speakers disposed in the second position area is equal to the second threshold 5. Thus, the first parameters reported by the speakers satisfy the target condition.

That is, as long as the number of speakers disposed in a position area is greater than or equal to the second threshold, it is determined that the first parameters reported by the speakers satisfy the target condition.

In some embodiments, the electronic device may also determine a quantity difference between the number of speakers disposed at a same position and the number of speakers disposed at a different same position, and compare the quantity difference with the second threshold (here refers to a threshold for the number of speakers) to obtain a comparison result. If the comparison result indicates that the quantity difference of the speakers is greater than or equal to the second threshold, it is determined that the first parameters reported by the speakers satisfy the target condition.

For example, the electronic device has a total of 10 speakers. Speakers 1-5 are disposed in the first position area, and speakers 6-10 are disposed in the second position area. Speakers 2 and 3 disposed in the first position area report their detected first parameters to the CPU. Speakers 6 to 10 disposed in the second position area all report their detected first parameters to the CPU. By obtaining the number of speakers and the speaker position information for the speakers that report their detected first parameters, it is determined that the number of speakers disposed in the first position area is 2, and the number of speakers disposed in the second location area is 5. There is a quantity difference 3 between 5 speakers disposed in the second location area and 2 speakers disposed in the first location area. By comparing the quantity difference 3 with the second threshold, it is determined that the quantity difference 3 is greater than the second threshold 2. Thus, it is determined that the first parameters reported by the speakers satisfy the target condition.

At 102, the plurality of speakers are controlled to change their first gain to a same second gain.

In some embodiments, when the electronic device determines that the first parameters of the speakers satisfy the target condition, the electronic device may send a first instruction to all the speakers on the electronic device through the CPU, such that each speaker changes its corresponding first gain to the same second gain based on the first instruction. The second gain is smaller than the first gain.

In some other embodiments, the electronic device may only send the first instruction to target speakers that report the first parameters, such that the target speakers adjust their current corresponding first gain to the same second gain as the other speakers in the electronic device based on the first instruction.

In some embodiments, when the electronic device controls the speakers to change their corresponding first gains to the same second gain, the electronic device may determine the corresponding second gain in the power supply signal threshold table based on the first parameters. The smaller the first parameter, the smaller the second gain.

For example, the speaker detects that a current voltage is 3.75V. Because 3.75V is smaller than the first threshold of 3.8V, the currently detected voltage data (3.75V) is reported to the CPU. 3.8V corresponds to a first gain A in the power supply signal threshold table. 3.75V corresponds to a second gain B in the power supply signal threshold table. The CPU sends the first instruction to the speakers to control the speakers to reduce from the first gain A to the second gain B based on the first instruction.

In another example, the speaker detects that the current voltage is 3.7V. Because 3.7V is smaller than the first threshold of 3.8V, the currently detected voltage data (3.7V) is reported to the CPU. 3.8V corresponds to the first gain A in the power supply signal threshold table. 3.7V corresponds to a third gain C in the power supply signal threshold table. The CPU sends the first instruction to the speakers to control the speakers to reduce from the first gain A to the third gain C based on the first instruction. The third gain C is smaller than the second gain B.

In some embodiments, when the electronic device controls the speakers to change from the corresponding first gain to the same second gain, the electronic device may also determine the corresponding second gain in the power supply signal threshold table based on the first parameters and the number of speakers corresponding to the first parameters. The smaller the first parameter, the smaller the second gain.

For example, the speaker detects that the current voltage is 3.75V. Because 3.75V is smaller than the first threshold of 3.8V, the currently detected voltage data (3.75V) is reported to the CPU. 3.8V corresponds to the first gain A in the power supply signal threshold table. 3.75V corresponds to the second gain B in the power supply signal threshold table. When the CPU receives the voltage data (3.75V) reported by the speakers, it may also count the number of speakers reporting the voltage data. If a count result indicates that the number of speakers reporting the voltage data (3.75V) is 6, which is greater than a preset number of speakers 5, then the CPU sends the first instruction to the speakers to control the speakers to reduce from the first gain A to the second gain B based on the first instruction.

In another example, the speaker detects that the current voltage is 3.7V. Because 3.7V is smaller than the first threshold of 3.8V, the currently detected voltage data (3.7V) is reported to the CPU. 3.8V corresponds to the first gain A in the power supply signal threshold table. 3.7V corresponds to the third gain C in the power supply signal threshold table. When the CPU receives the voltage data (3.7V) reported by the speakers, it may also count the number of speakers reporting the voltage data (3.7V). If the count result indicates that the number of speakers reporting the voltage data (3.7V) is 6, which is greater than the preset number of speakers 5, then the CPU sends the first instruction to the speakers to control the speakers to reduce from the first gain A to the third gain C based on the first instruction. The third gain C is smaller than the second gain B.

In some embodiments, when the electronic device controls the speakers to change from the corresponding first gain to the same second gain, the electronic device may also obtain a current gain of the speaker that has not sent the first parameter. The current gain of the speaker that has not sent the first parameter is sent to the speakers reporting the first parameters, such that the speakers reporting the first parameters adjust the current first gain to the second gain that is the same as the current gain of the speaker that has not sent the first parameter.

In this case, when the electronic device obtains the current gain of the speaker that has not sent the first parameter, it may specifically send an instruction to the speaker that has not sent the first parameter to obtain the currently detected power supply signal of the speaker that has not sent the first parameter. The electronic device may determine the corresponding target gain in the power supply signal table based on the power supply signal. The target gain is determined to be the current gain of the speaker that has not sent the first parameter.

In some embodiments, when it is determined that the first parameters of the multiple speakers do not satisfy the target condition, the electronic device may send a second instruction to the speakers through the CPU, such that the speakers maintain their current first gain based on the second instruction.

In some embodiments, the electronic device may send the second instruction through the CPU only to the speakers that report the first parameters, and may only cause the speaker that report the first parameters to keep the current first gain unchanged based on the second instruction.

In some other embodiments, the electronic device may send the second instruction to all speakers of the electronic device through the CPU, such that all speakers keep their current first gains unchanged based on the second instruction.

In this case, the first gains of all speakers may be the same or different.

For example, the electronic device may control the first gains of the speakers to be the same in an initial state. When the electronic device supplies power to the speakers through the battery within a preset time range (such as 1 hour), the speakers receive the power supply signals having differences smaller than a difference threshold (for example, 0.1V). At this time, the first gains of the speakers may be the same.

In another example, the electronic device may control the first gains of the speakers to be the same in the initial state. The electronic device uses the battery to power multiple speakers for a length of time (such as more than 1 hour) that is not within the preset time range (such as 1 hour). Because the speakers are disposed at different positions on the motherboard, the difference (such as 0.5V) of the power supply signals received by the speakers is greater than the difference threshold (such as 0.1V). At this time, the first gains of the speakers are different.

In some embodiments, before determining whether the first parameters of the speakers satisfy the target condition, the electronic device may also send a third instruction to the speakers through the CPU, such that the speakers send their self-detected power supply signals, that is, the first parameters, to the electronic device based on the third instruction. Thus, the power supply signals of the speakers can be obtained according to the needs of the electronic device.

In this case, the electronic device may send the third instruction to the speakers according to a preset interval time, or may send the third instruction to the speakers according to a received signal acquisition instruction.

In the embodiments of the present disclosure, the control method processes the power supply signals reported by the speakers. The number of speakers reporting the power supply signals is determined based on the processing results. When the number of speakers reporting the power supply signals is greater than or equal to the target threshold, the speakers are controlled to adjust their current gains to a same gain. When the number of speakers reporting the power supply signals is smaller than the target threshold, the speakers are controlled to maintain their current gains unchanged. In this way, the sound signals output by each of the plurality of speakers can be made to be the same, and the output sound signals of the plurality of speakers can be balanced, such that there is no difference in the sound volume heard by the user, and the user's listening experience is improved.

FIG. 2 is a flowchart of another exemplary control method according to some embodiments of the present disclosure. The control method may be applied to speakers in an electronic device. As shown in FIG. 2, the control method includes the following processes.

At 201, in response to a current first parameter reported by a speaker being determined to be smaller than a first threshold, the first parameter is sent to a control unit of the electronic device. The first parameter describes a power supply signal of the speaker.

In this case, the speaker may receive a power supply signal threshold table sent by a CPU of the electronic device through a speaker firmware during a startup process of the electronic device. The power supply signal threshold table includes relationships between power supply signal thresholds and gains for the speaker. Based on the power supply signal threshold table, whether a currently detected power supply signal (i.e., the current first parameter) is smaller than the first threshold is determined.

In some embodiments, when the speaker detects a power supply signal, the power supply signal is compared with the largest first threshold in the power supply signal threshold table. If the comparison result indicates that the power supply signal is smaller than the largest first threshold, then the power supply signal is sent to the control unit (such as CPU) of the electronic device. In this case, the power supply signal describes a current power supply voltage and/or a current power supply current of the speaker.

At 202, a first instruction sent by the control unit is received when the first parameter satisfies a target condition.

In this case, when receiving the first parameter sent by at least one speaker, the control unit of the electronic device may process the first parameter to determine whether the first parameter satisfies the target condition.

In some embodiments, the control unit of the electronic device may obtain the

power supply signal threshold table in the speaker firmware. Based on the power supply signal threshold table, the received first parameter is compared with the first threshold in the power supply signal threshold table (e.g., the maximum threshold in the threshold table). When it is determined that the first parameter is smaller than the first threshold according to the comparison result, it is determined that the first parameter satisfies the target condition, and the first instruction is sent to the speaker corresponding to the first parameter.

In some other embodiments, when determining that the first parameter is smaller than the first threshold, the control unit of the electronic device may also count the number of received first parameters to determine the speakers that sent the first parameters. The number of speakers is compared with the second threshold (here refers to a threshold for the number of speakers). If the comparison result indicates that the number of speakers is greater than or equal to the second threshold, it is determined that the first parameters satisfy the target condition, and the first instruction is sent to the speaker corresponding to the received first parameters, or to all speakers in the electronic device.

At 203, a current first gain is adjusted to a second gain that is same as a target speaker based on the first instruction.

In some embodiments, when the speaker in the electronic device receives the first instruction sent by the control unit of the electronic device, the speaker determines the second gain corresponding to a next threshold value of the first threshold in the power supply signal threshold table based on the first instruction, and adjusts its current first gain to the second gain. The second gain is the same as the current gain of other speakers in the electronic device, and the second gain is smaller than the first gain.

In some embodiments, the speaker may also receive a second instruction sent by the control unit of the electronic device when the first parameter does not satisfy the target condition. The current first gain remains unchanged based on the second instruction.

It should be noted that the control method provided by the above embodiments and the control method embodiment provided in FIG. 1 belong to the same concept. Specifically, it is the implementation of the control method embodiment provided in FIG. 1 for one of the speakers. For details of the implementation process, reference can be made to the description of the method embodiment in FIG. 1, which will be omitted herein.

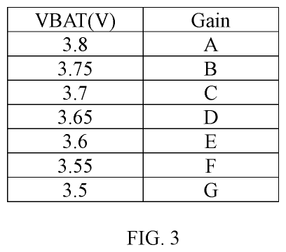

FIG. 3 is an exemplary power supply signal threshold table according to some embodiments of the present disclosure. As shown in FIG. 3, the power supply signal threshold table includes the correspondence relationship between voltage threshold values and signal gains. For example, 3.8V corresponds to gain A, 3.75V corresponds to gain B, 3.7V corresponds to gain C, 3.65V corresponds to gain D, 3.6V corresponds to gain E, 3.55V corresponds to gain F, and 3.5V corresponds to gain G.

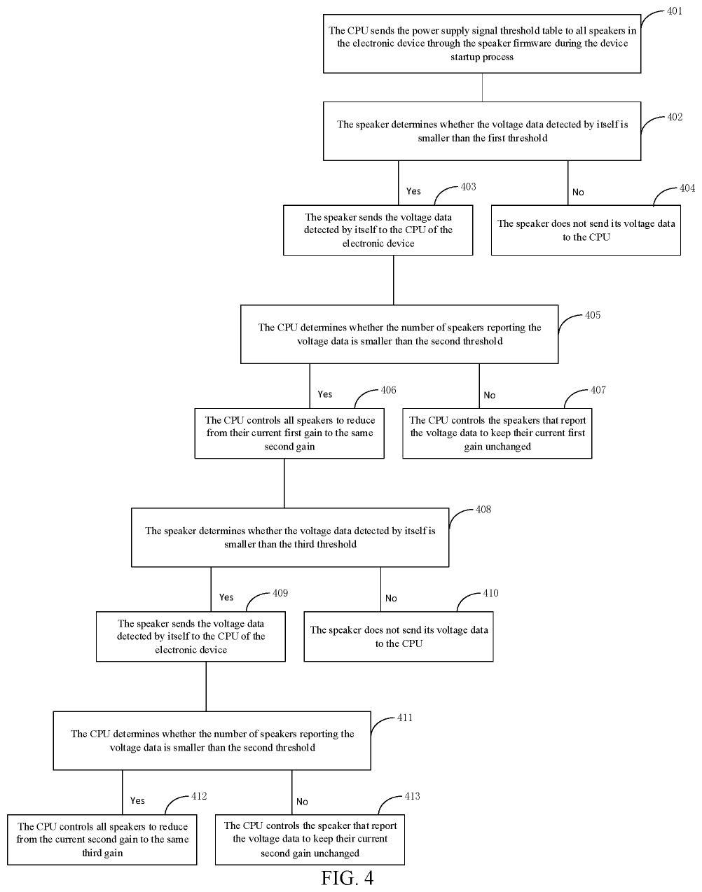

FIG. 4 is a flowchart of another exemplary control method according to some embodiments of the present disclosure. As shown in FIG. 4, the control method includes the following processes.

At 401, the CPU sends the power supply signal threshold table to all speakers in the electronic device through the speaker firmware during the device startup process.

In this case, the power supply signal threshold table stores the correspondence relationship between each voltage threshold value and the signal gain of that voltage threshold value.

At 402, the speaker determines whether the voltage data detected by itself is smaller than the first threshold.

In this case, if the voltage data detected by the speaker itself is smaller than the first threshold, 403 is executed. If the voltage data detected by the speaker itself is greater than or equal to the first threshold, 404 is executed.

For example, the speaker determines whether the voltage data it detects is smaller than 3.8V in the power supply signal threshold table.

At 403, the speaker sends the voltage data detected by itself to the CPU of the electronic device.

In this case, the speaker may send the voltage data to the CPU of the electronic device through a control interface on the electronic device. The control interface is different from the data interface of the electronic device. The difference may at least be reflected in that the control interface is used by the speaker to send the voltage data to the CPU. The control interface is also used for the CPU to send control instructions to the speaker (including the first instruction, the second instruction, and third instruction). The data interface is used for the CPU to send audio signal data to the speaker.

In this case, the control interface may be an inter-integrated circuit (I2C) interface or an improved inter-integrated circuit (I3C) interface. The data interface may be a time division multiplexed (TDM) interface.

At 404, the speaker does not send its voltage data to the CPU.

At 405, the CPU determines whether the number of speakers reporting the voltage data is smaller than the second threshold.

In this case, if the number of speakers reporting the voltage data is greater than or equal to the second threshold, 406 is executed. If the number of speakers reporting the voltage data is smaller than the second threshold, 407 is executed.

In this case, the second threshold may be greater than or equal to 2. For example, the CPU determines whether the number of speakers reporting the voltage data is smaller than 6.

At 406, the CPU controls all speakers to reduce from their current first gain to the same second gain.

For example, the CPU controls all speakers to reduce from the first gain A to the second gain B based on the power supply signal threshold table.

At 407, the CPU controls the speakers that report the voltage data to keep their current first gain unchanged.

At 408, the speaker determines whether the voltage data detected by itself is smaller than the third threshold.

In this case, if the voltage data detected by the speaker is smaller than the third threshold, 409 is executed. If the voltage data detected by the speaker is greater than or equal to the third threshold, 410 is executed.

In this case, the third threshold is smaller than the first threshold. For example, the speaker determines whether the voltage data detected by itself is smaller than 3.75V in the power supply signal threshold table.

At 409, the speaker sends the voltage data detected by itself to the CPU of the electronic device.

In this case, the speaker may send the voltage data detected by itself to the CPU of the electronic device through the control interface on the electronic device. The control interface is different from the data interface of the electronic device. The difference may at least be reflected in that the control interface is used by the speaker to send the voltage data to the CPU. The control interface is also used for the CPU to send control instructions to the speaker (including the first instruction, the second instruction, and the third instruction). The data interface is used for the CPU to send audio signal data to the speaker.

For example, the control interface may be the I2C interface. The data interface may be the TDM interface.

At 410, the speaker does not send its voltage data to the CPU. At 411, the CPU determines whether the number of speakers reporting the voltage data is smaller than the second threshold.

In this case, if the number of speakers reporting the voltage data is greater than or equal to the second threshold, 412 is executed. If the number of speakers reporting the voltage data is smaller than the second threshold, 413 is executed.

In this case, the second threshold may be greater than or equal to 2.

For example, the CPU determines whether the number of speakers reporting the voltage data is smaller than 6.

At 412, the CPU controls all speakers to reduce from the current second gain to the same third gain.

For example, the CPU controls all speakers to reduce from the second gain B to the third gain C based on the power supply signal threshold table.

At 413, the CPU controls the speaker that report the voltage data to keep their current second gain unchanged.

The process continues until the speaker detects whether its own voltage is smaller than the smallest threshold in the power supply signal threshold table.

For example, the process continues until the speaker detects whether its own voltage is smaller than 3.5V in the power supply signal threshold table.

In the embodiments of the present disclosure, the control method processes the power supply signals reported by the speakers. When the number of speakers reporting their power supply signals is determined to be greater than or equal to the target threshold according to the processing results, the speakers are controlled to adjust their gains to be the same. In this way, the sound signal output by each of the speakers at any time can be the same, such that the sound volume heard by the user will also be consistent.

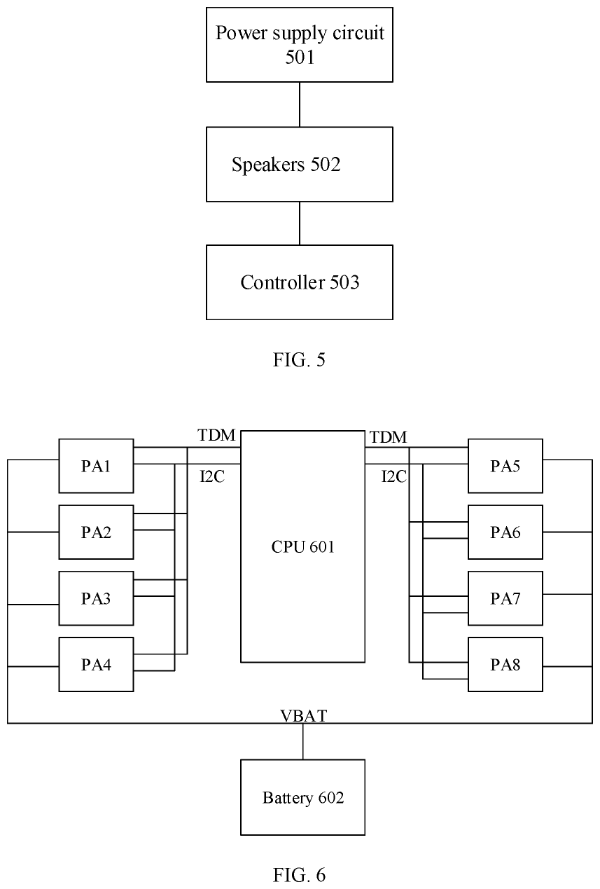

FIG. 5 is a schematic structural diagram of an exemplary electronic device according to some embodiments of the present disclosure. As shown in FIG. 5, the electronic device includes a power supply circuit 501 configured to at least provide power to a plurality of speakers, the plurality of speakers 502 disposed at different positions of the power supply circuit 501 for outputting audio signals, and a controller 503 connected to the plurality of speakers 502 and configured to receive the first parameters sent by at least one speaker through a first interface. When it is determined that the first parameters sent by the plurality of speakers 502 satisfy the target condition, the controller 503 controls the plurality of speakers 502 to change from corresponding first gains to the same second gain.

In this case, the controller 503 may be the CPU in the electronic device. The power supply circuit 501 may be the battery in the electronic device.

In some embodiments, the controller 503 is also configured to send the audio signal to the plurality of speakers through the second interface, such that the plurality of speakers output the audio signal.

In this case, the first interface is different from the second interface. The first interface may be an interface used for sending the power supply signals and the control instructions between the controller and the speaker. The second interface may be an interface used for sending the audio signals between the controller and the speaker. For example, the first interface may be the I2C or I3C interface, and the second interface may be the TDM interface.

In some embodiments, the controller 503 is also configured to control the plurality of speakers 502 to keep their current first gain unchanged when it is determined that the first parameters reported by the plurality of speakers 502 do not satisfy the target condition.

It should be noted that the electronic device provided by the embodiments of the present disclosure and the control method embodiment provided above belong to the same concept. For details of how the electronic device provided by the embodiments of the present disclosure controls the speaker, reference can be made to the method embodiment, which will be omitted herein.

FIG. 6 is a schematic structural diagram of another exemplary electronic device according to some embodiments of the present disclosure. As shown in FIG. 6, the electronic device includes speaker 1 (PA1), speaker 2 (PA2), speaker 3 (PA3), speaker 4 (PA4), speaker 5 (PAS), speaker 6 (PA6), speaker 7 (PA7), and speaker 8 (PA8). First ends of speaker 1 to speaker 8 are connected to CPU 601 through an I2C interface respectively, and second ends of speaker 1 to speaker 8 are respectively connected to the battery 602 through a VBAT interface. When the battery 602 supplies power to the speaker 1 to speaker 8, each speaker may detect a power supply signal from the battery 601, and may detect whether the power supply signal it receives satisfies a target condition. For example, when speaker 1 (PA1) and speaker 6 (PA6) detect that their power supply voltage is lower than 3.8V, speaker 1 (PA1) and speaker 6 (PA6) report their power supply signals to the CPU through the I2C interface. When the CPU detects that the number of speakers reporting voltage data is ≤2, the CPU sends the second instruction to speaker 1 (PA1) and speaker 6 (PA6) through the I2C interface, such that speaker 1 (PA1) and speaker 6 (PA6) maintain their gain A unchanged based on the second instruction. In another example, when speaker 1 (PA1), speaker 3 (PA3), speaker 4 (PA4), speaker 5 (PA5), speaker 7 (PA7), and speaker 8 (PA8) all detect that their power supply voltage is lower than 3.8V, they report their power supply voltage to the CPU through the I2C interface respectively. When the CPU detects that the number of speakers reporting the voltage data is ≥6, the CPU sends the first instruction to all speakers (PA1-PA8) through the I2C interface such that all speakers will reduce their current gain to the same gain B. The process continues until the speaker detects a power supply voltage below 3.5V or lower.

In another example, when speaker 1 (PA1), speaker 5 (PAS), speaker 6 (PA6), speaker 7 (PA7), and speaker 8 (PA8) detect that their power supply voltage is lower than 3.8V, they report their power supply voltage to the CPU through the I2C interface. Based on the speaker position information of the voltage data, it is determined that there is one speaker disposed in the first position area, which is speaker 1 (PA1), and there are four speakers disposed in the second position area, which are speaker 5 (PAS), speaker 6 (PA6), speaker 7 (PA7), and speaker 8 (PA8). Even if the number of speakers 1 disposed in the first position area is smaller than the second threshold 3, but the number 4 of speakers disposed in the second position area is greater than the second threshold 3, the CPU will send the first instruction to all speakers (PA1-PA8) through the I2C interface, such that all speakers reduce their current gain to the same gain B based on the first instruction.

Alternatively, the CPU subtracts the number 1 of speakers disposed in the first position area from the number 4 of speakers disposed in the second position area, and determines that the difference between the number of speakers disposed in the second position area and the number of speakers disposed in the first position area is 3. The quantity difference 3 is compared with the second threshold 3 to determine that the speaker number difference 3 is equal to the second threshold 3. The CPU will send the first instruction to all speakers (PA1-PA8) through the I2C interface, such that all speakers will reduce their current gain to the same gain B based on the first instruction. In this way, the sound volume heard by the user can be consistent.

In this case, the CPU 601 is also connected to speaker 1 (PA1), speaker 2 (PA2), speaker 3 (PA3), speaker 4 (PA4), speaker 5 (PA5), speaker 6 (PA6), speaker 7 (PA7), and speaker 8 (PA8) through the TDM interface to send the audio signal to each speaker through the TDM interface.

The present disclosure also provides an electronic device. The electronic device includes: a processor and a memory for storing a computer program that can run on the processor. When being executed by the processor, the computer program causes the processor to perform any processes in the above-described method embodiments.

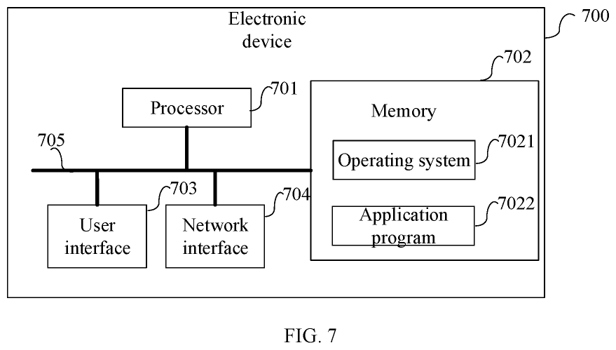

FIG. 7 is a schematic structural diagram of another exemplary electronic device according to some embodiments of the present disclosure. The electronic device 700 may be a terminal capable of outputting audio, such as a mobile phone, a computer, a digital broadcast terminal, an information transceiver, a game console, a tablet device, a medical device, a fitness device, a personal digital assistant, etc. As shown in FIG. 7, the electronic device 700 includes: at least one processor 701, a memory 702, at least one network interface 704, and a user interface 703. Various components in the electronic device 700 are coupled together by a bus system 705. It should be understood that the bus system 705 is used to implement communication between these components. In addition to a data bus, the bus system 705 also includes a power bus, a control bus, and a status signal bus. However, for the sake of clarity, the various buses are aggregately labeled as the bus system 705 in FIG. 7.

The user interface 703 may include a display, a keyboard, a mouse, a trackball, a click wheel, keys, buttons, a touch pad, or a touch screen, etc.

It should be understood that the memory 702 may be a volatile memory, a non-volatile memory, or a combination thereof. The non-volatile memory may be a read-only memory (ROM), a programmable read-only memory (PROM), an erasable programmable read-only memory (EPROM), an electrically erasable programmable read-only memory (EEPROM), a ferromagnetic random-access memory (FRAM), a flash memory, a magnetic surface memory, an optical disk, or a compact disc read-only memory (CD-ROM). The magnetic surface memory may be a magnetic disk memory or a tape memory. The volatile memory may be a random-access memory (RAM), which is used as an external cache. For purpose of illustration, but not limitation, many types of RAMs are available, such as a static random-access memory (SRAM), a synchronous static random-access Memory (SSRAM), a dynamic random-access memory (DRAM), a synchronous dynamic random-access memory (SDRAM), a double data rate synchronous dynamic random-access memory (DDRSDRAM), an enhanced synchronous dynamic random-access memory (ESDRAM), a SyncLink dynamic random-access memory (SLDRAM), and a direct rambus random-access memory (DRRAM)). The memory 702 described in the embodiments of the present disclosure is intended to include, but is not limited to, these and any other suitable types of memories.

In the embodiments of the present disclosure, memory 702 is used to store various types of data to support the operation of the electronic device 700. Examples of these data include: any computer program used to operate on the electronic device 700, such as an operating system 7021 and an application program 7022; contact data; phonebook data; messages; pictures; and audio data, etc. The operating system 7021 includes various system programs, such as a framework layer, a core library layer, and a driver layer, etc., which are used to implement various basic services and process hardware-based tasks. The application program 7022 may include various application programs, such as a media player, and a browser, etc., and may be used to implement various application services. The program that implements the control method of the embodiments of the present disclosure may be included in the application program 7022.

The methods disclosed in the embodiments of the present disclosure may be applied to processor 701 or may be implemented by the processor 701. The processor 701 may be an integrated circuit chip with signal processing capabilities. During the implementation process, processes of the control method may be completed by instructions in the form of hardware integrated logic circuits or software in the processor 701. The processor 701 may be a general-purpose processor, a digital signal processor (DSP), other programmable logic devices, discrete gates or transistor logic devices, or discrete hardware components, etc. The processor 701 may implement or execute the control method, the processes of the control method, and logic block diagrams disclosed in the embodiments of the present disclosure. The general-purpose processor may be a microprocessor or any conventional processor, etc. The processes of the control method disclosed in the embodiments of the present disclosure may be directly implemented by a hardware decoding processor, or may be executed by a combination of hardware and software modules in the decoding processor. The software modules may be located in a storage medium, and the storage medium may be located in memory 702. The processor 701 reads the information in memory 702, and completes the processes of the control method in combination with its hardware.

In some embodiments, the electronic device 700 may be configured by one or more application specific integrated circuits (ASICs), digital signal processors (DSPs), programmable logic devices (PLDs), complex programmable logic devices (CPLDs), field-programmable gate arrays (FPGAs), general-purpose processors, controllers, microcontrollers, micro controller units (MCUs), microprocessors, or other electronic component implementation used to execute the control methods.

The present disclosure also provides a computer-readable storage medium, such as the memory 702 including a computer program. The computer program may be executed by processor 701 of the electronic device 700 to complete the processes of the control method. The computer-readable storage medium may be a FRAM, a ROM, a PROM, an EPROM, an EEPROM, a flash memory, a magnetic surface memory, an optical disk, or a CD-ROM. The computer-readable storage medium may also be various devices including one or any combination of the above-described memories, such as mobile phones, computers, tablet devices, personal digital assistants, etc.

When being executed by a processor, the computer program stored on the computer-readable storage medium implements any one of the disclosed control methods.

In the embodiments of the present disclosure, the disclosed electronic devices and control methods may be implemented in other ways. The device embodiments described above are intended to be exemplary. For example, division of the units/modules is only a logical function division. In actual implementations, there may be other division methods, such as: multiple units or components may be combined, or can be integrated into another system, or some features may be ignored, or not implemented. In addition, coupling, direct coupling, or communication connection between the components shown or discussed may be through some interfaces, and indirect coupling or communication connection of the devices or units may be electrical, mechanical, or other forms.

The units described above as separate components may or may not be physically separated. The components shown as units may or may not be physical units, that is, they may be located in one place or distributed to multiple network units. Some or all of the units may be selected according to actual needs to achieve the objectives of the technical solutions of the present disclosure.

The methods disclosed in various method embodiments of the present disclosure may be combined arbitrarily to obtain new method embodiments without conflict.

The features disclosed in various product embodiments of the present disclosure may be combined arbitrarily without conflict to obtain new product embodiments.

The features disclosed in various method or device embodiments of the present disclosure may be combined arbitrarily without conflict to obtain new method embodiments or device embodiments.

The above are merely some embodiments of the present disclosure. The protection scope of the present disclosure is not limited thereto. Those of ordinary skill in the art may easily think of modifications or substitutions within the technical scope disclosed in the present disclosure, and such modifications or substitutions should be covered by the protection scope of the present disclosure. Therefore, the protection scope of the present disclosure should be subject to the appended claims.

What is claimed is:

1. A control method, comprising:
determining whether first parameters reported by a plurality of speakers satisfy a target condition, the plurality of speakers being disposed at different positions in an electronic device, and each first parameter describing a power supply signal of each speaker; and
controlling the plurality of speakers to change their first gain to a same second gain.

2. The control method according to claim 1, wherein determining whether the first parameters reported by the plurality of speakers satisfy the target condition comprises:
determining a number of speakers reporting the first parameters that are smaller than a first threshold; and
in response to the number of speakers being greater or equal to a second threshold, determining the first parameters reported by the plurality of speakers satisfying the target condition.

3. The control method according to claim 1, wherein controlling the plurality of speakers to change their first gain to the same second gain comprises:
sending a first instruction to the plurality of speakers, such the plurality of speakers adjust their first gain to the same second gain based on the first instruction, the second gain being smaller the first gain.

4. The control method according to claim 2, further comprising:
in response to the number of speakers being smaller than the second threshold, determining that the first parameters reported by the plurality of speakers do not satisfy the target condition; and
sending a second instruction to the plurality of speakers, such that the plurality of speakers maintain their current first gain.

5. The control method according to claim 1, before determining whether the first parameters reported by the plurality of speakers satisfy the target condition, further comprising at least one of:
receiving the first parameters sent by at least one speaker under the circumstance that the first parameters are smaller than a first threshold; or
sending a third instruction to the plurality of speakers, such that the plurality of speakers report their first parameters based on the third instruction.

6. The control method according to claim 1, wherein controlling the plurality of speakers to change their first gain to the same second gain comprises:
based on the first parameters, determining the second gain, wherein the smaller the first parameter, the smaller the second gain; or
based on the first parameters and the number of speakers reporting the first parameters, determining the second gain, wherein the smaller the first parameter, the smaller the second gain.

7. A control method being applied to a speaker of an electronic device, comprising:
in response to determining that a first parameter is smaller than a first threshold, sending the first parameter to a control unit of the electronic device, the first parameter describing a power supply signal of the speaker;
receiving a first instruction sent from the control unit under the circumstance that the first parameter satisfies a target condition; and
based on the first instruction, adjusting a current first gain to a second gain that is same as a target speaker.

8. The control method according to claim 7, further comprising:
receiving a second instruction sent from the control unit under the circumstance that the first parameter does not satisfy the target condition; and
based on the second instruction, maintaining the current first gain.

9. An electronic device, comprising:
a power supply circuit configured to at least supply power to a plurality of speakers;
the plurality of speakers disposed at different positions of the power supply circuit for outputting audio signals; and
a controller connected to the plurality of speakers and configured to receive first parameters sent by at least one speaker through a first interface, and to control the plurality of speakers to change their first gain to a same second gain under the circumstance that the first parameters reported by the plurality of speakers satisfy a target condition.

10. The electronic device according to claim 9, wherein:
the controller is further configured to send audio signals to the plurality of speakers through a second interface, such that the plurality of speakers output the audio signals.

11. The electronic device according to claim 9, wherein the controller is further configured to:
determine a number of speakers reporting the first parameters that are smaller than a first threshold; and
in response to the number of speakers being greater or equal to a second threshold, determine that the first parameters reported by the plurality of speakers satisfying the target condition.

12. The electronic device according to claim 9, wherein the controller is further configured to:
send a first instruction to the plurality of speakers, such the plurality of speakers adjust their first gain to the same second gain based on the first instruction, the second gain being smaller the first gain.

13. The electronic device according to claim 11, wherein the controller is further configured to:
in response to the number of speakers being smaller than the second threshold, determine that the first parameters reported by the plurality of speakers do not satisfy the target condition; and
send a second instruction to the plurality of speakers, such that the plurality of speakers maintain their current first gain.

14. The electronic device according to claim 9, wherein the controller is further configured to:
receive the first parameters sent by at least one speaker under the circumstance that the first parameters are smaller than the first threshold; or send a third instruction to the plurality of speakers, such that the plurality of speakers report their first parameters based on the third instruction.

15. The electronic device according to claim 9, wherein the controller is further configured to:
based on the first parameters, determine the second gain, wherein the smaller the first parameter, the smaller the second gain; or
based on the first parameters and the number of speakers reporting the first parameters, determine the second gain, wherein the smaller the first parameter, the smaller the second gain.
